(19) United States
(12) Patent Application Publication
(10) Pub. No.: US 2026/0084214 A1
(43) Pub. Date: Mar. 26, 2026

(54) LASER ADDITIVE MANUFACTURING TITANIUM-STEEL MULTI-MATERIAL COMPONENT HAVING IMPROVED INTERFACE BONDING AND FORMABILITY BY SUPPRESSING ELEMENT DIFFUSION THROUGH INTERMEDIATE LAYER, APPARATUS AND METHOD THEREOF

(71) Applicant: NANJING UNIVERSITY OF AERONAUTICS AND ASTRONAUTICS, Jiangsu (CN)

(72) Inventors: Dongdong GU, Jiangsu (CN); Ziqi GUO, Jiangsu (CN); He SUN, Jiangsu (CN); Guangjing HUANG, Jiangsu (CN); Kuanyang FENG, Jiangsu (CN); Rui SHENG, Jiangsu (CN)

(73) Assignee: NANJING UNIVERSITY OF AERONAUTICS AND ASTRONAUTICS, Jiangsu (CN)

(21) Appl. No.: 19/337,940

(22) Filed: Sep. 24, 2025

(30) Foreign Application Priority Data
Sep. 24, 2024 (CN) 202411333880.4

(51) Int. Cl. B22F 10/28; B22F 1/052; B22F 10/322; B22F 10/366; B22F 10/85; B33Y 10/00; B33Y 50/02; B33Y 70/00

(52) U.S. Cl. CPC B22F 10/28; B22F 1/052; B22F 10/322; B22F 10/366; B22F 10/85; B22F 2301/205; B22F 2301/35; B22F 2301/45; B22F 2304/10; B33Y 10/00; B33Y 50/02; B33Y 70/00

(57) ABSTRACT

The present disclosure discloses a laser additive manufacturing titanium-steel multi-material component having an improved interface bonding and formability by suppressing an element diffusion through an intermediate layer, as well as an apparatus and a method thereof. The laser additive manufacturing titanium-steel multi-material component comprises a titanium alloy layer, an intermediate layer and a stainless steel layer, the intermediate layer includes an elemental metal Ce layer and an elemental metal Cr layer, and the titanium alloy layer, the elemental metal Ce layer, the elemental metal Cr layer and the stainless steel layer are sequentially deposited through a laser directed energy deposition process.

### CROSS-REFERENCE TO RELATED APPLICATION

This application claims the priority benefit of China application serial no. 202411333880.4, filed on Sep. 24, 2024. The entirety of the above-mentioned patent application is hereby incorporated by reference herein and made a part of this specification.

### BACKGROUND

### Technical Field

The present disclosure relates to a laser additive manufacturing titanium-steel multi-material component having an improved interface bonding and formability by suppressing an element diffusion through an intermediate layer, an apparatus and a method thereof, which belongs to the technical field of metal laser additive manufacturing.

### Description of Related Art

The traditional technical method can manufacture multi-material components with simple geometric structures, but cannot manufacture components with complex structures and multifunctional characteristics, and the multi-material laser additive manufacturing technology provides a novel way for preparing components with specific physical performances, can realize good metallurgical bonding of various materials, and can also prepare complex structural components. Laser additive manufacturing has been widely studied and used in manufacturing technology for the last decade because of the inherent flexibility and high efficiency in producing complex components. The traditional laser additive manufacturing is limited to one material, so that it cannot guarantee that the components have characteristics such as wear resistance, high temperature resistance, and corrosion resistance while maintaining strength and low cost, whereas the emerging multi material laser additive manufacturing technology can eliminate these problems.

Laser Directed Energy Deposition (LDED) is an advanced additive manufacturing technique that can directly manufacture high density, functional components, in the manufacturing process, the laser beam is focused on the substrate to form a molten pool, and the powder flow is continuously input into the molten pool through a transporting system and melted, and eventually the printing and forming are carried out. Due to the advantages of small heat affected zone, small solidification structure and the like, and the method is beneficial to preparing the multi-material component. The titanium alloy has the advantages of light weight, high strength, corrosion resistance, biocompatibility and the like, and the stainless steel has the advantages of high strength, corrosion resistance, easiness in processing, low cost and the like, so that a good metallurgical bonding between the titanium alloy and the stainless steel has an important significance for industrial development. However, because the metallurgical and thermal physical performances of the two materials are different, the two materials cannot be mixed and melted, and when the two materials are directly connected with each other, a plurality of Ti-Fe brittle intermetallic compounds are generated, so that the defects of interface cracking, holes and the like are caused, the interface bonding strength is currently reduced, and the industrial application of the two materials is severely limited.

### SUMMARY

The present disclosure aims to provide a laser additive manufacturing titanium-steel multi-material component having an improved interface bonding and formability by suppressing an element diffusion through an intermediate layer, an apparatus and a method thereof, in which the intermediate layer capable of blocking Ti and Fe elements from diffusing is arranged between a titanium alloy layer and a stainless steel layer, therefore, harmful brittle fracture caused by unmatched atomic structure and thermal expansion coefficient can be effectively avoided, and the titanium-steel multi-material component with good metallurgical bonding interface and excellent performance can be obtained.

In order to achieve the above technical objectives, the present disclosure adopts the following technical solutions.

Provided is a laser additive manufacturing titanium-steel multi-material component. The multi-material component comprises a titanium alloy layer, an intermediate layer and a stainless steel layer, the intermediate layer includes an elemental metal Ce layer and an elemental metal Cr layer; the titanium alloy layer, the elemental metal Ce layer, the elemental metal Cr layer and the stainless steel layer are sequentially deposited from bottom to top through a laser directed energy deposition process.

Preferably, the titanium alloy layer is formed by laser sintering to melt titanium alloy powder, the elemental metal Ce layer is formed by laser sintering to melt elemental metal Ce powder, the elemental metal Cr layer is formed by laser sintering to melt elemental metal Cr powder, and the stainless steel layer is formed by laser sintering to melt stainless steel powder.

Preferably, the number of layers of the elemental metal Ce layer and the elemental metal Cr layer is two.

Preferably, the titanium alloy powder is TC4 powder, a particle size of the TC4 powder ranges from 53 μm to 150 μm, and in the TC4 powder, an Al content is 6.75 wt. %, a V content is 4.5 wt. %, and a remainder is Ti.

The stainless steel powder is SS316 powder, a particle size of the SS316 powder ranges from 53 μm to 150 μm, and in the SS316 powder is 18.0 wt. %, a Ni content is 10.0 wt. %, a Mo content is 2.5 wt. %, and a remainder is Fe.

Another technical object of the present disclosure is to provide a titanium-steel multi-material laser additive manufacturing apparatus having an improved interface bonding and formability by suppressing an element diffusion through an intermediate layer, constructed based on a laser directed energy deposition process, configured to manufacture a titanium-steel multi-material component by laser additive, including a protective chamber, a powder feeder, a print working head, a forming substrate, and a controller, the nozzle is integrated with a powder transportation pipe, a laser, and a shielding gas transporting pipe; the forming substrate is arranged in the protective chamber, the powder feeder contains powder to be printed, and the printing powder contained in the powder feeder is transportable to a printing area on the forming substrate through the powder transportation pipe; the laser beam spots emitted by a laser are capable of falling on the printing area on the forming substrate, shielding gas is transportable to the printing area on the forming substrate through a shielding gas transporting pipe, the forming substrate is a titanium alloy substrate, the powder feeder contains four types of printing powders, and the four types of printing powders are titanium alloy powder, elemental metal Ce powder, elemental metal Cr powder and stainless steel powder, correspondingly.

A powder processing file is created based on the structural characteristics of the titanium-steel multi-material component in the controller, four sets of powder processing data are integrated in the powder processing file, and each set of powder processing data is provided with laser printing process parameters and corresponding laser scanning path planning.

The four sets of powder processing data are first to fourth powder processing data, correspondingly, the first set of powder processing data is used for depositing and melting the titanium alloy powder to form a titanium alloy layer, the second set of powder processing data is used for depositing and melting the elemental metal Ce powder to form an elemental metal Ce layer, the third set of powder processing data is used for depositing and melting the elemental metal Cr powder to form an elemental metal Cr layer, and the fourth set of powder processing data is used for depositing and melting the stainless steel powder to form a stainless steel layer.

Under a control of the controller, after a laser power and a scanning speed of a laser beam output by the laser are controlled according to the laser printing process parameters in the first set of powder processing data, the powder transportation pipe is started to transport titanium alloy powder contained in the powder feeder to the printing area, then the working head is controlled to actuate according to a laser scanning path planning in the first set of powder processing data until a deposition of the titanium alloy layer is completed on the titanium alloy substrate; the type of powder transported by the powder transportation pipe is switched to enable the powder transportation pipe to transport the elemental metal Ce powder contained in the powder feeder to the printing area, the working head is controlled to actuate according to the laser scanning path planning in the second set of powder processing data until deposition of a preset number of the elemental metal Ce layers is completed on the titanium alloy layer, a type of powder transported by the powder transportation pipe is switched to enable the powder transportation pipe to transport the elemental metal Cr powder contained in the powder feeder to the printing area, and the working head is controlled to actuate according to the laser scanning path planning in the third set of powder processing data until deposition of a preset number of the elemental metal Cr layers is completed on the elemental metal Ce layer, and the type of powder transported by the powder transportation pipe is switched to enable the powder transportation pipe to transport the stainless steel powder contained in the powder feeder to the printing area, and the working head is controlled to actuate according to the laser scanning path planning in the fourth set of powder processing data until deposition of the stainless steel layer is completed on the elemental metal Cr layers, to obtain titanium-steel multi-material components.

Another technical objective of the present disclosure is to provide a method for improving an interface bonding and formability by suppressing an element diffusion through an intermediate layer in a titanium-steel multi-material laser additive manufacturing, which is implemented based on the titanium-steel multi-material laser additive manufacturing apparatus having the improved interface bonding and formability by suppressing the element diffusion through the intermediate layer, after a titanium alloy substrate is cleaned, a laser directed energy deposition process is adopted, and a titanium alloy layer, an elemental metal Ce layer, an elemental metal Cr layer and a stainless steel layer are sequentially deposited on a surface of the titanium alloy substrate through controlling a powder feeding rate, a laser focus offset, an overlap ratio and a shielding gas flow, so that a titanium-steel multi-material component with good metallurgical bonding and excellent performance is prepared, and the method specifically comprises the following steps.

In Step 1, Powder drying.

Titanium alloy powder, elemental metal Ce powder, elemental metal Cr powder and stainless steel powder are respectively placed into a vacuum drying oven at 80° C. for drying for 10 hours to remove water and improve a fluidity of the powder, and the powder is placed into a powder feeder after drying is completed.

In Step 2, powder processing data are created.

Based on the laser directed energy deposition process, four sets of mutually independent powder processing data are created, and each set of powder processing data is configured with laser printing process parameters and laser scanning path planning.

The four sets of powder processing data are first to fourth powder processing data, correspondingly.

The first set of powder processing data is used for depositing and fusing the titanium alloy powder to form the titanium alloy layer.

The second set of powder processing data is used for depositing and fusing the elemental metal Ce powder to form the elemental metal Ce layer.

The third set of powder processing data is used for depositing and fusing the elemental metal Cr powder to form the elemental metal Cr layer.

The fourth set of powder processing data is used for depositing and fusing the stainless steel powder to form the stainless steel layer.

In Step 3, the titanium alloy substrate is placed into a protective chamber. An industrial robot is controlled to adjust the laser focus offset, after which the chamber door is closed. Pure argon is then introduced to deoxidize.

In Step 4, after an oxygen content in the protective chamber is reduced to 50 ppm, a laser is started to sequentially deposit different materials on the titanium alloy substrate to obtain the titanium-steel multi-material component with a sound metallurgical interface e. The deposition specifically comprises the following sub-steps.

In Step 4.1, the first set of powder processing data in Step 2 is loaded to deposit a titanium alloy layer on the titanium alloy substrate.

In Step 4.2, after the titanium alloy layer is deposited, the laser focus offset is adjusted by taking a top surface of the titanium alloy layer as a reference, and the second set of powder processing data in Step 2 is loaded to deposit an elemental metal Ce layer on a surface of the titanium alloy layer.

In Step 4.3, after the elemental metal Ce layer is deposited, the laser focus offset is adjusted by taking a top surface of the elemental metal Ce layer as a reference, and the third set of powder processing data in Step 2 is loaded to deposit an elemental metal Cr layer on a surface of the elemental metal Ce layer.

In Step 4.4, after the elemental metal Cr layer is deposited, the laser focus offset is adjusted by taking a top surface of the elemental metal Cr layer as a reference, the fourth set of powder processing data in Step 2 is loaded to deposit a stainless steel layer on a surface of the elemental metal Cr layer, and the titanium-steel multi-material component with good metallurgical bonding interface is eventually obtained.

Preferably, the powder feeding rate is 10 g/min, the laser focus offset ranges from 2 mm to 3 mm, the overlap ratio is 50%, and the shielding gas flow ranges from 14 L/min to 16 L/min.

Preferably, a particle size of TC4 powder ranges from 53 μm to 150 μm, in the TC4 powder, an Al content is 6.75 wt. %, a V content is 4.5 wt. %, and a remainder is Ti. A particle size of the SS316 powder ranges from 53 μm to 150 μm, in the SS316 powder, a Cr content is 18.0 wt. %, a Ni content is 10.0 wt. %, a Mo content is 2.5 wt. %, and a remainder is Fe.

A particle size of elemental metal Ce powder ranges from 20 μm to 130 μm; Preferably, a particle size of elemental metal Cr powder ranges from 20 μm to 130 μm.

Preferably, in the first set of powder processing data, a laser power is 700 W and a scanning speed is 10 mm/s.

In the second set of powder processing data, a laser power is 700 W, and a scanning speed is 10 mm/s.

In the third set of powder processing data, a laser power is 900 W, and a scanning speed is 10 mm/s.

In the fourth set of powder processing data, a laser power is 1000 W and a scanning speed is 8 mm/s.

Preferably, after the titanium alloy layer is deposited on the titanium alloy substrate, Step 4.2 is repeated to deposit more than two elemental metal Ce layers on the titanium alloy layer, and after the elemental metal Ce layers is deposited, Step 4.3 is repeated to deposit more than two elemental metal Cr layers on the elemental metal Ce layers.

Based on the technical objectives, the present disclosure has the following advantages in comparison with the prior art,
1. In a laser additive manufacturing titanium-steel multi-material component having an improved interface bonding and formability by suppressing an element diffusion through an intermediate layer according to the present disclosure, the elemental metal Ce layer and the elemental metal Cr layer are sequentially deposited between the titanium alloy layer and the stainless steel layer, so that the diffusion of Ti and Fe elements can be effectively blocked, and finally the titanium-steel multi-material component taking the stainless steel layer and the titanium alloy layer as the outer layers is prepared. Therefore, the titanium-steel multi-material component in the present disclosure can simultaneously have the advantages of titanium alloy and stainless steel (generally, the titanium alloy has the advantages of high specific strength, good heat resistance and low temperature resistance, good shock resistance and the like, and the stainless steel has the advantages of excellent mechanical performance, good corrosion resistance, low cost and the like), on the other hand, by utilizing the characteristic of mutual dissolution of Ce and Cr, the effective blocking of Ti and Fe elements can be realized by sequentially depositing an elemental metal Ce layer and an elemental metal Cr layer between the titanium alloy layer and the stainless steel layer, and the corrosion resistance and the oxidation resistance of the titanium alloy material can be improved by the elemental metal Ce, and good metallurgical bonding of the elemental metal Cr and the stainless steel material can be realized. Therefore, the present disclosure realizes good metallurgical bonding of the titanium-steel multi-material under the action of the intermediate layer, and solves the problems of interface cracking, holes and the like caused by brittle intermetallic compounds when titanium alloy and stainless steel are directly connected.
2. The present disclosure prepares the multi-material component by using the laser directed energy deposition technology, has the advantages of different materials, such as local heat resistance, corrosion resistance, high heat conduction, wear resistance, can precisely control the material distribution, can print specific materials in a specific position by a unique structure, realizes specific functions, and realizes more excellent comprehensive performance.
3. The multi-material additive manufacturing technology can better adapt to different working condition environments by unique structural design and material distribution, especially under severe working conditions requiring multi-function and multi-environment adaptability, thereby providing a novel choice for development in the fields of aerospace, nuclear industry, medical treatment, automobile manufacturing and the like.

### BRIEF DESCRIPTION OF THE DRAWINGS

FIG. 1 illustrates a schematic diagram of a titanium-steel multi-material componentdeposited by a titanium-steel multi-material laser additive manufacturing apparatus according to the present disclosure.

In the figure, 1—a laser, 2—a powder transportation pipe, 3—a shielding gas transporting pipe, 4—a substrate, 51—a titanium alloy layer, 52—an intermediate layer and 53—a stainless steel layer are arranged.

FIG. 2 illustrates a schematic diagram of a laser scanning strategy according to the present disclosure.

FIG. 3 illustrates an OM image of Cr and SS316 interface of a titanium-steel multi-material component in Example 3 of the present disclosure.

FIG. 4 illustrates an OM image of Cr and SS316 interface of a titanium-steel multi-material component in Example 4 of the present disclosure.

FIG. 5 illustrates an OM image of Cr and SS316 interface of a titanium-steel multi-material component in Example 5 of the present disclosure.

FIG. 6 illustrates a macroscopic image of a direct connection between a laser directed energy deposited TC4 titanium alloy and an SS316 stainless steel in accordance with the present disclosure.

### DESCRIPTION OF THE EMBODIMENTS

The embodiments of the present disclosure will be made clearly and completely described with reference to the accompanying drawings, in which it is apparent that the embodiments described are merely one part of embodiments of the present disclosure, but not all embodiments. The following descriptions of at least one exemplary embodiment are merely exemplary in nature and is in no way intended to limit the present disclosure, its application, or uses. All other embodiments, which can be made by those skilled in the art based on the embodiments of the present disclosure without making any inventive effort, are intended to be within the protection scope of the present disclosure. The relative arrangement, expressions and numerical values of the members and steps set forth in these embodiments do not limit the scope of the present disclosure unless it is specifically stated otherwise. Techniques, methods, and apparatus known to one of ordinary skill in the relevant art may not be discussed in detail, but are intended to be part of the specification where appropriate. In all examples shown and discussed herein, an arbitrary one of specific values should be construed as merely illustrative, and not a limitation. Thus, other examples of the exemplary embodiments may have different values.

The titanium alloy has the advantages of high specific strength, good heat resistance and low temperature resistance, good shock resistance and the like, and the stainless steel has the advantages of excellent mechanical performance, good corrosion resistance, low cost and the like. When the stainless steel and the titanium alloy can be effectively connected with each other, the advantages of the two materials can be simultaneously achieved. However, since the difference in physical performances (such as thermal expansion coefficient, thermal conductivity) between titanium alloy and stainless steel is great, a large amount of brittle intermetallic compounds are generated at the interface when the two materials are directly connected with each other, and residual stress and a large amount of strain are generated, thereby leading to connection failure. FIG. 6 discloses a macroscopic image of direct connection between a laser directed energy deposited TC4 titanium alloy and SS316 stainless steel, and it can be observed that many cracks appear on the surface of SS316, the quality of the interface metallurgical bonding is poor, and the SS316 portion falls off during final wire cutting, indicating that a large amount of brittle intermetallic compounds are generated between the stainless steel and the titanium alloy to cause connection failure.

In order to implement effective joining between the stainless steel and the titanium alloy, the elemental metal Ce and the elemental metal Cr are introduced between the two materials. The mutual solubility characteristic between the elemental metal Ce and the elemental metal Cr blocks the diffusion of Ti and Fe elements. As a result, good metallurgical bonding between the stainless steel and the titanium alloy is implemented, so that the problems of interface cracking, voids and the like caused by brittle intermetallic compounds when the titanium alloy and the stainless steel are directly connected are solved.

To this end, the present disclosure discloses a laser additive manufacturing titanium-steel multi-material component, as well as an apparatus and a method thereof. The following describes the technical solutions of the present disclosure in detail with reference to the examples.

### EXAMPLE 1

This example discloses a laser additive manufacturing titanium-steel multi-material component, which comprises a titanium alloy layer 51, an intermediate layer 52 and a stainless steel layer 53. The intermediate layer 52 comprises an elemental metal Ce layer and an elemental metal Cr layer, and the titanium alloy layer 51, the elemental metal Ce layer, the elemental metal Cr layer and the stainless steel layer 53 are sequentially deposited from bottom to top through a laser directed energy deposition process. The titanium alloy layer 51 is formed by melting titanium alloy powder through laser sintering, the titanium alloy powder can be TC4 powder, the particle size of the TC4 powder ranges from 53 μm to 150 μm, the content of Al in the TC4 powder is 6.75 wt. %, the content of V is 4.5 wt. %, and the remainder is Ti, and it is certain that the titanium alloy powder can also be selected from other titanium alloy powders corresponding to the existing model. The elemental metal Ce layer is formed by melting elemental metal Ce powder through laser sintering, the particle size of the elemental metal Ce powder ranges from 20 μm to 130 μm, the elemental metal Cr layer is formed by melting elemental metal Cr powder through laser sintering, the particle size of the elemental metal Cr powder ranges from 20 μm to 130 μm, the stainless steel layer 53 is formed by melting stainless steel powder through laser sintering, the stainless steel powder can be SS316 powder, the particle size of the SS316 powder ranges from 53 μm to 150 μm, in the SS316 powder, the Cr content is 18.0 wt. %, the Ni content is 10.0 wt. %, the Mo content is 2.5 wt. %, and the remainder is Fe. It is certain that the stainless steel powder can be selected from other stainless steel powder corresponding to the existing model.

The number of layers of the elemental metal Ce layer and the elemental metal Cr layer can be determined according to actual requirements, and tests show that when the number of layers of the elemental metal Ce layer and the elemental metal Cr layer is two, the interface metallurgical bonding of the titanium-steel multi-material component is good, with almost no defects, except for a few tiny hole, which indicates that the two layers of elemental metal Ce layers and the two layers of elemental metal Cr layers can effectively suppress the diffusion of Ti and Fe elements, so that brittle intermetallic compounds are prevented from being generated, stress is reduced, and cracks are prevented from being generated and expanded, thereby achieving the purpose of improving comprehensive mechanical performances.

### EXAMPLE 2

This example discloses a titanium-steel multi-material laser additive manufacturing apparatus having an improved interface bonding and formability by suppressing an element diffusion through an intermediate layer, constructed based on a laser directed energy deposition process, and configured to manufacture the titanium-steel multi-material component in Example 1. Under the action of the focused laser beam, the printing powder flows into the molten pool and melts, and the titanium alloy and the stainless steel can be connected with each other basically without cracks through the preferable intermediate layer 52, and the printing powder has excellent mechanical performance.

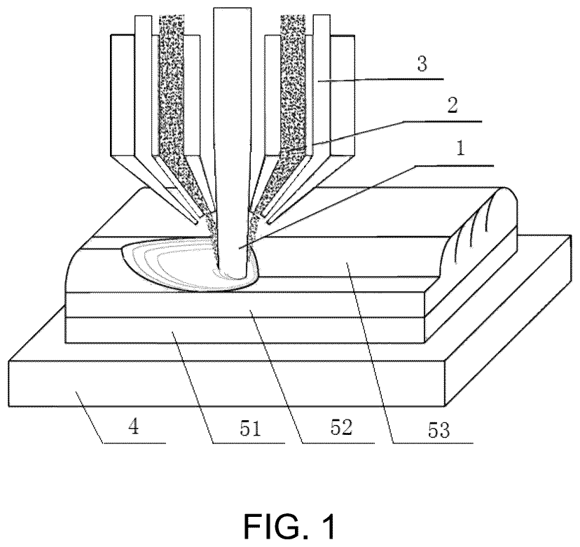

As illustrated in FIG. 1, the titanium-steel multi-material laser additive manufacturing apparatus in this Example includes a protective chamber, a powder feeder, a nozzle, a forming substrate and a controller, the nozzle is integrated with a powder transportation pipe 2, a laser 1 and a shielding gas transporting pipe 3, the forming substrate is placed in the protective chamber, the powder feeder contains powder to be printed, the printing powder contained in the powder feeder is transportable to a printing area on the forming substrate through the powder transportation pipe 2, a laser beam spot emitted by the laser 1 can fall on the printing area on the forming substrate, shielding gas is transportable to the printing area on the forming substrate through the shielding gas transporting pipe 3, the forming substrate is a titanium alloy substrate, and four types of printing powder are contained in the powder feeder, that are, titanium alloy powder, elemental metal Ce powder, elemental metal Cr powder and stainless steel powder.

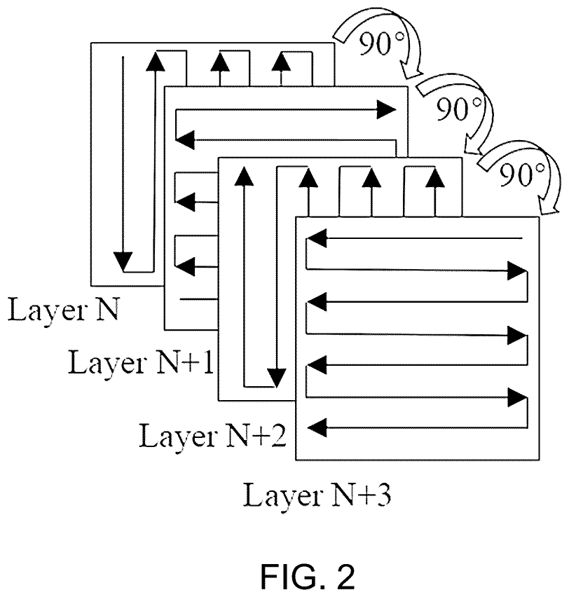

A powder processing file is constructed based on the structural characteristics of the titanium-steel multi-material component in the controller, four sets of powder processing data are integrated in the powder processing file, and each set of powder processing data is provided with laser printing process parameters and corresponding laser scanning path planning. The laser printing process parameters include laser power and scan speed. The laser scanning path planning adopts a reciprocating scanning strategy, and referring to FIG. 2, the initial point of laser melting of each layer is different, and each layer rotates by 90°, so that the sample can be uniformly heated, and the surface is smooth.

The four sets of powder processing data are first to fourth set of powder processing data, correspondingly, the first set of powder processing data are used for depositing and melting the titanium alloy powder to form the titanium alloy layer 51, the second set of powder processing data are used for depositing and melting the elemental metal Ce powder to form the elemental metal Ce layer, the third set of powder processing data are used for depositing and melting the elemental metal Cr powder to form the elemental metal Cr layer, and the fourth set of powder processing data are used for depositing and melting the stainless steel powder to form the stainless steel layer 53.

Under the control of a controller, after the laser power and scanning speed of a laser beam output by a laser 1 are controlled according to laser printing process parameters in the first set of powder processing data, a powder transportation pipe 2 is started to transport titanium alloy powder contained in the powder feeder to a printing area, then the working head is controlled to actuate according to a laser scanning path planning in the first set of powder processing data until deposition of a titanium alloy layer 51 is completed on a titanium alloy substrate, the type of powder transported by the powder transportation pipe 2 is switched, so that elemental metal Ce powder contained in the powder is transported to the printing area through the powder transportation pipe 2, and the working head is controlled to actuate according to the laser scanning path planning in the second set of powder processing data until deposition of a preset number of elemental metal Ce layers is completed on the titanium alloy layer 51, the type of powder transported by the powder transportation pipe 2 is switched, so that the elemental metal Cr powder contained in the powder is transported to the printing area powder through transporting pipe, and the working head is controlled to actuate according to the laser scanning path planning in third set of powder processing data until deposition of a preset number of elemental metal Cr layers is completed on the elemental metal layer, and the elemental metal Ce layer is transported to the stainless steel layer 53, to obtain titanium-steel multi-material components.

### EXAMPLE 3

This example discloses a method for improving an interface bonding and formability by suppressing an element diffusion through an intermediate layer in a titanium-steel multi-material laser additive manufacturing, implemented based on the titanium-steel multi-material laser additive manufacturing apparatus having the improved interface bonding and formability by suppressing the element diffusion through the intermediate layer, and after a titanium alloy substrate is cleaned, a laser directed energy deposition process is adopted, and a titanium alloy layer 51, an elemental metal Ce layer, an elemental metal Cr layer and a stainless steel layer 53 are sequentially deposited on the surface of the titanium alloy substrate through controlling a powder feeding rate, a laser focus offset, an overlap ratio and a shielding gas flow, so that a titanium-steel multi-material component with good metallurgical bonding at the interface and excellent performance is prepared. The powder feeding rate is 10 g/min, the laser focus offset ranges from 2 mm to 3 mm, the overlap ratio is 50%, and the shielding gas flow ranges from 14 L/min to 16 L/min.

Specifically, the method for improving an interface bonding and formability by suppressing an element diffusion through an intermediate layer in a titanium-steel multi-material laser additive manufacturing according to this example comprises the following steps.

In Step 1, powder drying.

Titanium alloy powder, elemental metal Ce powder, elemental metal Cr powder and stainless steel powder are respectively placed into a vacuum drying oven at 80° C. for drying for 10 hours to remove water and improve the fluidity of the powder, and the powder is placed into a powder feeder after drying is completed, the powder feeding rate of the powder feeder is 10 g/min.

In Step 2, powder processing data are created.

Based on the LDED (laser directed energy deposition) process, four mutually independent sets of powder processing data are created. Each set of powder processing data is configured with laser printing process parameters and laser scanning path planning. And then a controller is adopted to integrate the four sets of powder processing data into a single powder processing file, thereby enabling one-to-one control of the printing powder for each layer to complete the deposition process.

The four sets of powder processing data are designated as first through fourth powder processing data, correspondingly.

The first set of powder processing data is used for depositing and fusing the titanium alloy powder to form titanium alloy layer 51.

The second set of powder processing data is used for depositing and fusing the elemental metal Ce powder to form an elemental metal Ce layer.

The third set of powder processing data is used for depositing and fusing elemental metal Cr powder to form an elemental metal Cr layer.

The fourth set of powder processing data is used for depositing and fusing stainless steel powder to form stainless steel layer 53.

In Step 3, the titanium alloy substrate is placed into a protective chamber after cleaning, then an industrial robot is controlled to adjust the laser focus offset of a working head to be in a range from 2 mm to 3 mm, a cabin door is closed after adjusting, and pure argon is introduced to deoxidize, the shielding gas flow ranges from 14 L/min to 16 L/min.

In Step 4, after the oxygen content in the protective chamber is reduced to 50 ppm, the laser 1 is started to sequentially deposit different materials on the titanium alloy substrate to obtain a titanium-steel multi-material component with good metallurgical bonding interface, which specifically comprises the following steps.

In Step 4.1, the first set of powder processing data is loaded in the Step 2 to deposit a titanium alloy layer 51 on the titanium alloy substrate.

In Step 4.2, after the titanium alloy layer 51 is deposited, the laser focus offset is adjusted by taking the top surface of the titanium alloy layer 51 as a reference, and the second set of powder processing data in Step 2 are loaded to deposit an elemental metal Ce layer on the surface of the titanium alloy layer 51.

In Step 4.3, after the elemental metal Ce layer is deposited, the laser focus offset is adjusted by taking the top surface of the elemental metal Ce layer as a reference, and the third set of powder processing data in Step 2 are loaded to deposit an elemental metal Cr layer on the surface of the elemental metal Ce layer.

Step 4.4, after the elemental metal Cr layer is deposited, the laser focus offset is adjusted by taking the top surface of the elemental metal Cr layer as a reference, the fourth set of powder processing data in Step 2 are loaded to deposit a stainless steel layer 53 on the surface of the elemental metal Cr layer, and the titanium-steel multi-material component with good metallurgical bonding interface is finally obtained.

In Step 5, the sample is cut from the substrate by adopting a spark-erosion wire after the preparation is completed, an oil stain cleaning agent is put into the sample to ultrasonically clean and remove surface stains, subsequently, the titanium-steel multi-material sample is grinded and polished according to a standard metallographic preparation method, and an interface is observed under an optical microscope.

### EXAMPLE 4

This example differs from Example 3 in the following.

In Step 1, the titanium alloy powder is TC4 powder, the particle size of the TC4 powder ranges from 53 μm to 150 μm, in the TC4 powder, the Al content is 6.75 wt. %, the V content is 4.5 wt. %, the remainder is Ti, the stainless steel powder is SS316 powder, the particle size of the SS316 powder ranges from 53 μm to 150 μm, in the SS316 powder, the Cr content is 18.0 wt. %, the Ni content is 10.0 wt. %, the Mo content is 2.5 wt. %, and the remainder is Fe. The particle size of the elemental metal Ce powder ranges from 20 μm to 130 μm, and the particle size of the elemental metal Cr powder ranges from 20 μm to 130 μm.

In Step 4, Step 4.1 is repeatedly implemented, four layers of titanium alloy layers 51 are continuously deposited on a titanium alloy substrate, the laser process parameters for the deposited titanium alloy layers 51 are that laser power is 700 W, the scanning speed is 10 mm/s, after the deposition of four layers of titanium alloy layers 51 are completed, the surface of the uppermost layer of titanium alloy layers 51 is used as a reference, Step 4.2 is repeatedly implemented, two layers of elemental metal Ce layers are continuously deposited on the titanium alloy layers 51, the laser process parameters of the deposited elemental metal Ce layers are that the laser power is 700 W, the scanning speed is 10 mm/s, after two layers of elemental metal Ce layers is deposited, the surface of the uppermost layer of elemental metal Ce layer is used as a reference, Step 4.3 is repeatedly implemented to deposit two layers of elemental metal Cr layers on the elemental metal Ce layers, the laser process parameters for depositing the elemental metal Cr layers are that the laser power is 900 W, the scanning speed is 10 mm/s, after two layers of elemental metal Cr layers is deposited, the surface of the uppermost layer of elemental metal Cr layer is used as a reference, and Step 4.4 is implemented to deposit two layers of stainless steel layer 53 on the elemental metal Cr layer, and finally a titanium-steel multi-material component with good metallurgical bonding and excellent performance at the interface is formed, the laser process parameters for depositing stainless steel layer 53 are that laser power of 1000 W, scanning speed of 8 mm/s.

In the titanium-steel multi-material component prepared in this example, the average thickness of two elemental metal Ce layers is 1.06 mm, and the average thickness of two elemental metal Cr layers is 1.05 mm.

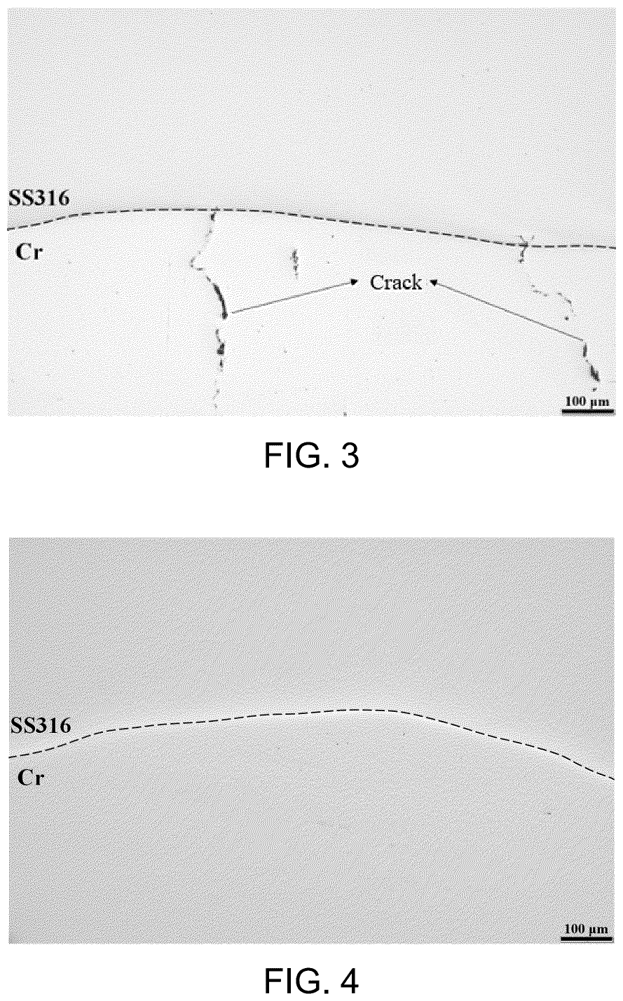

The sample is cut from the substrate by adopting a spark-erosion wire after the preparation is completed, an oil stain cleaning agent is put into the sample to ultrasonically clean and remove surface stains, subsequently, the titanium-steel multi-material sample is grinded and polished according to a standard metallographic preparation method, and an interface is observed under an optical microscope as illustrated in FIG. 3.

By observing the interfacial optical image of the titanium-steel multi-material component illustrated in FIG. 3, it can be seen that the metallurgical bonding of the interface is good, with almost no defects, except for a few tiny holes, which indicates that two layers of intermediate layers 52 can effectively suppress the diffusion of Ti and Fe elements, so that brittle intermetallic compounds are prevented from being generated, stress is reduced, and cracks are prevented from being generated and expanded, thereby achieving the purpose of improving the comprehensive mechanical performances.

### EXAMPLE 5

The difference between this example and Example 4 is that the elemental metal Ce layer and the elemental metal Cr layer is one layer. The prepared titanium-steel multi-material component is subjected to grinding and polishing treatment according to a standard metallographic preparation method, and an interface is observed under an optical microscope as illustrated in FIG. 4.

In the titanium-steel multi-material component prepared in this example, the average thickness of one layer of the elemental metal Ce layer is 0.45 mm, and the average thickness of one layer of the elemental metal Cr layer is 0.5 mm.

By comparing the OM pictures of Example 4 and Example 5, it can be seen that the titanium-steel multi-material component prepared in this example has vertical cracks and holes, which indicates that the effect of blocking element is limited when the intermediate blocking layer (one layer of elemental metal Ce layer, one layer of elemental metal Cr layer) is thinner, and brittle intermetallic compounds are generated at the interface, thereby greatly reducing the comprehensive mechanical performances of the titanium-steel multi-material.

### EXAMPLE 6

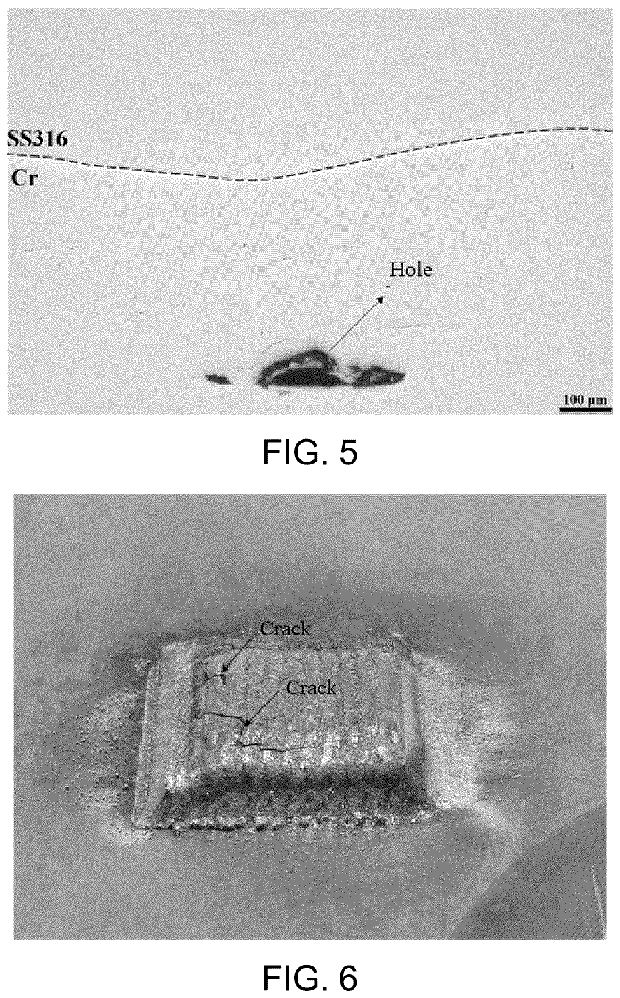

The difference between this example and Example 4 is that the elemental metal Ce layer and the elemental metal Cr layer are all three layers. The prepared titanium-steel multi-material component is subjected to grinding and polishing treatment according to a standard metallographic preparation method, and an interface is observed under an optical microscope as illustrated in FIG. 5.

In the titanium-steel multi-material component prepared in this example, the average thickness of the three layers of elemental metal Ce layers is 1.2 mm, and the average thickness of the three layers of elemental metal Cr layers is 1.5 mm.

By comparing the OM pictures of Example 4 and Example 6, it can be seen that the titanium-steel multi-material component prepared in this example has large holes in the intermediate blocking layer, which indicates that the thickness of the intermediate blocking layer is too large and the defects will increase accordingly. Therefore, the thickness of the intermediate blocking layer should be controlled well to connect the multiple materials, which not only can control the defects, but also can improve the comprehensive mechanical performances of the titanium-steel multi-material.

As is clear from a comprehensive comparison of Example 4 to Example 6, for a specific powder material (TC 4 titanium alloy powder, SS316 stainless steel powder), under the control of specific laser power, scanning speed and laser focus offset, an elemental metal Ce layer and an elemental metal Cr layer with a thickness in the range from 1 mm to 1.2 mm are sequentially formed between the titanium alloy layer 51 and the stainless steel layer 53, and effective blocking of Ti and Fe elements between the titanium alloy layer 51 and the stainless steel layer 53 can be effectively implemented, so that a titanium-steel multi-material component with good interface bonding and excellent performance is obtained. In fact, the thickness of the intermediate blocking layer varies for different powder materials, different process conditions (laser power, scanning speed, laser focus offset), but the overall control objective is to implement an effective blocking of Ti, Fe elements.

### COMPARATIVE EXAMPLE

The comparative example provides a method for depositing a titanium-steel multi-material component by utilizing laser directed energy deposition. In the method, after melting and depositing TC4 titanium alloy powder on a titanium alloy substrate to form a titanium alloy layer 51, SS316 stainless steel powder is directly melted and deposited on the titanium alloy layer 51, which specifically comprises the following steps.
(1) A proper amount of TC4 and SS316 powder is taken, the powder is placed into a vacuum drying oven, dried at 80° C. for 10 h ours to remove water and improve the powder fluidity, and the powder is placed into a powder feeder after drying.
(2) The industrial robot (namely the above controller) is started, to program and plan laser power, scanning speed and scanning path of different materials, which is specifically divided into TC4 and SS316 processing data files.
(3) A powder feeder, a water cooler, a laser 1 and an oxygen content detector are sequentially started, the titanium alloy substrate is put into a protective chamber after cleaning, an industrial robot is controlled to adjust laser focus offset, close a cabin door after adjusting, 99.9% pure argon is introduced, and printing is started when the oxygen content is reduced to below 50 ppm.
(4) Firstly, four layers of TC4 are deposited on a titanium alloy substrate, the laser power is 700 W, the scanning speed is 10 mm/s, then two layers of SS316 are deposited by taking the TC4 surface as a reference, the laser power is 1000 W, the scanning speed is 8 mm/s, finally, printing and forming are carried out, and a macroscopic image is as illustrated in FIG. 6. It can be seen that there are a plurality of cracks on the surface of SS316, the interface metallurgical bonding quality is poor, and parts of the SS316 falls off during final wire cutting, indicating that stainless steel and titanium alloys can produce a significant amount of brittle intermetallic compounds without the interlayer 52 blocking element, resulting in failure of the connection.

What is claimed is:

1. A laser additive manufacturing titanium-steel multi-material component, having an improved interface bonding and formability by suppressing an element diffusion through an intermediate layer, comprising a titanium alloy layer, an intermediate layer and a stainless steel layer, wherein the intermediate layer comprises an elemental metal Ce layer and an elemental metal Cr layer; the titanium alloy layer, the elemental metal Ce layer, the elemental metal Cr layer and the stainless steel layer are all deposited sequentially from bottom to top through a laser directed energy deposition process, and a number of layers of the elemental metal Ce layer and the elemental metal Cr layer is two.

2. The laser additive manufacturing titanium-steel multi-material component, having the improved interface bonding and formability by suppressing the element diffusion through the intermediate layer according to claim 1, wherein the titanium alloy layer is formed by laser sintering to melt titanium alloy powder, the elemental metal Ce layer is formed by laser sintering to melt an elemental metal Ce powder, the elemental metal Cr layer is formed by laser sintering to melt an elemental metal Cr powder, and the stainless steel layer is formed by laser sintering to melt a stainless steel powder.

3. The laser additive manufacturing titanium-steel multi-material component, having the improved interface bonding and formability by suppressing the element diffusion through the intermediate layer according to claim 2, wherein the titanium alloy powder is a TC4 powder, a particle size of the TC4 powder ranges from 53 μm to 150 μm, and in the TC4 powder, an Al content is 6.75 wt. %, a V content is 4.5 wt. %, and a remainder is Ti; the stainless steel powder is a SS316 powder, a particle size of the SS316 powder ranges from 53 μm to 150 μm, and in the SS316 powder, a Cr content is 18.0 wt. %, a Ni content is 10.0 wt. %, a Mo content is 2.5 wt. %, and a remainder is Fe.

4. A titanium-steel multi-material laser additive manufacturing apparatus having an improved interface bonding and formability by suppressing an element diffusion through an intermediate layer, constructed based on a laser directed energy deposition process, configured to manufacture a titanium-steel multi-material component by laser additive, and comprising a protective chamber, a powder feeder, a working head for printing, a forming substrate and a controller, wherein the working head for printing is integrated with a powder transportation pipe, a laser and a shielding gas transporting pipe; the forming substrate is arranged in the protective chamber, the powder feeder contains powder to be printed, the printing powder contained in the powder feeder is transportable to a printing area on the forming substrate through the powder transportation pipe, laser beam spots emitted by the laser are capable of falling on the printing area on the forming substrate, and a shielding gas is transportable to the printing area on the forming substrate through the shielding gas transporting pipe; wherein the forming substrate is a titanium alloy substrate; the powder feeder contains four types of printing powders, that are, a titanium alloy powder, an elemental metal Ce powder, an elemental metal Cr powder, and a stainless steel powder, correspondingly;
a powder processing file is created based on the structural characteristics of the titanium-steel multi-material component in the controller, wherein four sets of powder processing data are integrated in the powder processing file, and each set of powder processing data is provided with laser printing process parameters and corresponding laser scanning path planning;
the four sets of powder processing data are first to fourth set of powder processing data, correspondingly, wherein the first set of powder processing data is used for depositing and melting the titanium alloy powder to form a titanium alloy layer, the second set of powder processing data is used for depositing and melting the elemental metal Ce powder to form an elemental metal Ce layer, the third set of powder processing data is used for depositing and melting the elemental metal Cr powder to form an elemental metal Cr layer, and the fourth set of powder processing data is used for depositing and melting the stainless steel powder to form a stainless steel layer;
under a control of the controller, after a laser power and a scanning speed of a laser beam output by the laser are controlled according to the laser printing process parameters in the first set of powder processing data, the powder transportation pipe is started to transport the titanium alloy powder contained in the powder feeder to the printing area, then the working head is controlled to actuate according to a laser scanning path planning in the first set of powder processing data until a deposition of the titanium alloy layer is completed on the titanium alloy substrate; the type of powder transported by the powder transportation pipe is switched to enable the powder transportation pipe to transport the elemental metal Ce powder contained in the powder feeder to the printing area, and the working head is controlled to actuate according to a laser scanning path planning in the second set of powder processing data until deposition of two layers of the elemental metal Ce layers is completed on the titanium alloy layer, and a type of powder transported by the powder transportation pipe is switched to enable the powder transportation pipe to transport the elemental metal Cr powder contained in the powder feeder to the printing area, and the working head is controlled to actuate according to a laser scanning path planning in the third set of powder processing data until deposition of two layers of the elemental metal Cr layers is completed on the elemental metal Ce layer, and the type of powder transported by the powder transportation pipe is switched to enable the powder transportation pipe to transport the stainless steel powder contained in the powder feeder to the printing area and the working head is controlled to actuate according to a laser scanning path planning in the fourth set of powder processing data until deposition of the stainless steel layer is completed on the elemental metal Cr layers, to obtain titanium-steel multi-material components.

5. A method for improving an interface bonding and formability by suppressing an element diffusion through an intermediate layer in a titanium-steel multi-material laser additive manufacturing, implemented based on the titanium-steel multi-material laser additive manufacturing apparatus having the improved interface bonding and formability by suppressing the element diffusion through the intermediate layer in claim 4, wherein after the titanium alloy substrate is cleaned, the laser directed energy deposition process is adopted, and the titanium alloy layer, the elemental metal Ce layer, the elemental metal Cr layer and the stainless steel layer are sequentially deposited on a surface of the titanium alloy substrate through controlling a powder feeding rate, a laser focus offset, an overlap ratio and a shielding gas flow, so that a titanium-steel multi-material component with good metallurgical bonding interface and excellent performance is prepared, and the method specifically comprises following steps:
a step 1, powder drying:
respectively placing the titanium alloy powder, the elemental metal Ce powder, the elemental metal Cr powder and the stainless steel powder into a vacuum drying oven at 80° C. for drying for

10. hours to remove water and improve a fluidity of the powder, and placing, after the drying is completed, the powder into the powder feeder;
a step 2, creating powder processing data:
creating, based on the laser directed energy deposition process, the four sets of mutually independent powder processing data, and configuring each set of powder processing data with the laser printing process parameters and the laser scanning path planning;
the four sets of powder processing data being first to fourth powder processing data, correspondingly, wherein:
the first set of powder processing data is used for depositing and melting the titanium alloy powder to form the titanium alloy layer;
the second set of powder processing data is used for depositing and melting the elemental metal Ce powder to form the elemental metal Ce layer;
the third set of powder processing data is used for depositing and melting the elemental metal Cr powder to form the elemental metal Cr layer;
the fourth set of powder processing data is used for depositing and melting the stainless steel powder to form the stainless steel layer;
a step 3, placing the titanium alloy substrate into the protective chamber, controlling an industrial robot to adjust the laser focus offset, closing, after the adjustment is completed, a cabin door of the protective chamber, and introducing pure argon to deoxidize;
a step 4, starting, after an oxygen content in the protective chamber is reduced to 50 ppm, a laser to sequentially deposit different materials on the titanium alloy substrate to obtain the titanium-steel multi-material component with good metallurgical bonding interface, and specifically comprising following steps:
a step 4.1, loading the first set of powder processing data in the step 2 to deposit the titanium alloy layer on the titanium alloy substrate;
a step 4.2, adjusting, after the titanium alloy layer is deposited, the laser focus offset by taking a top surface of the titanium alloy layer as a reference, and loading the second set of powder processing data in the step 2 to deposit the two layers of the elemental metal Ce layers on a surface of the titanium alloy layer;
a step 4.3, adjusting, after the elemental metal Ce layer is deposited, the laser focus offset by taking a top surface of the elemental metal Ce layer as a reference, and loading the third set of powder processing data in the step 2 to deposit the two layers of the elemental metal Cr layers on a surface of the elemental metal Ce layer; and
a step 4.4, adjusting, after the elemental metal Cr layer is deposited, the laser focus offset by taking a top surface of the elemental metal Cr layer as a reference, loading the fourth set of powder processing data in the step 2 to deposit the stainless steel layer on a surface of the elemental metal Cr layer, and eventually obtaining the titanium-steel multi-material component with good metallurgical bonding interface.

6. The method for improving the interface bonding and formability by suppressing the element diffusion through the intermediate layer in the titanium-steel multi-material laser additive manufacturing according to claim 5, wherein the powder feeding rate is 10 g/min, the laser focus offset ranges from 2 mm to 3 mm, the overlap ratio is 50%, and the shielding gas flow ranges from 14 L/min to 16 L/min.

7. The method for improving the interface bonding and formability by suppressing the element diffusion through the intermediate layer in the titanium-steel multi-material laser additive manufacturing according to claim 5, wherein a particle size of a TC4 powder ranges from 53 μm to 150 μm, and in the TC4 powder, an Al content is 6.75 wt. %, a V content is 4.5 wt. %, and a remainder is Ti; a particle size of a SS316 powder ranges from 53 μm to 150 μm, in the SS316 powder, a Cr content is 18.0 wt. %, a Ni content is 10.0 wt. %, a Mo content is 2.5 wt. %, and a remainder is Fe;
a particle size of the elemental metal Ce powder ranges from 20 μm to 130 μm, and a particle size of the elemental metal Cr powder ranges from 20 μm to 130 μm.

8. The method for improving the interface bonding and formability by suppressing the element diffusion through the intermediate layer in the titanium-steel multi-material laser additive manufacturing according to claim 5, wherein in the first set of powder processing data, a laser power is 700 W and a scanning speed is 10 mm/s;
in the second set of powder processing data, a laser power is 700 W, and a scanning speed is 10 mm/s;
in the third set of powder processing data, a laser power is 900 W, and a scanning speed is 10 mm/s;
in the fourth set of powder processing data, a laser power is 1000 W and a scanning speed is 8 mm/s.
